(19) United States
(12) Patent Application Publication
(10) Pub. No.: US 2010/0259613 A1
(43) Pub. Date: Oct. 14, 2010

(54) WATCHING CAMERA

(75) Inventor: Han Mo LEE, Seoul (KR)

Correspondence Address: LRK Patent Law Firm, 1952 Gallows Rd, Suite 200, Vienna, VA, 22182, US

(73) Assignee: APRO TECHNOLOGY CO., LTD., Bucheon (KR)

(21) Appl. No.: 12/701,294

(22) Filed: Feb. 5, 2010

(30) Foreign Application Priority Data
Apr. 13, 2009 (KR) 10-2009-31952

(51) Int. Cl. H04N 7/18; H04N 5/225

(52) U.S. Cl. 348/143; 348/373; 348/E07.085; 348/E05.022

(57) ABSTRACT

According to the present invention, there is provided a watching camera, comprising: a housing main body that is fixedly installed at a wall surface or a ceiling of a building; a camera module that is installed at the housing main body to acquire image information on a watching region; an angle control bracket that is installed at the bottom of the housing main body and is mounted to allow the camera module to have a multi-shaft freedom in up, down, left and right directions; and a horizontal display device that is installed at the camera module and light-emits a lamp in response to a slope in a left and right direction of the camera module.

The present invention according to the above-mentioned configuration includes the horizontal display device on the front surface of the camera module to confirm the horizontality of the camera screen with the naked eye of the worker, thereby directly controlling the horizontality of the screen of the camera on the spot without performing the separate monitoring operation. As a result, the installation can be very easily and conveniently performed, such that the installation time and construction time of the watching camera can be shortened, thereby making it possible to reduce the cost of construction.

### TECHNICAL FIELD

The present invention relates to a watching camera, and more particularly, to a watching camera capable of confirming a horizontal state of a screen during the installation of the watching camera.

### BACKGROUND ART

In general, a watching camera is installed inside and outside an office, a house, a hospital, a bank, public buildings that requires security, etc. and has been widely used for entrance or exit management or crime prevention. In recent, the watching camera has been mainly installed in an underground parking lot where crimes frequently occur, a road on which illegal parking is performed, etc., or residential areas where various accidents frequently occur, and the like.

Most watching cameras have been installed in a space, which is out of reach of a person's hand, such as a wall surface, a ceiling, etc. In addition to a watching camera that is designed to photograph only a one direction, a dome-type watching camera, which can optionally control a photographing direction regardless of an installation position or a space, has been emerged.

The watching camera can control a photographing direction and includes a lamp using an infrared LED, such that it can perform photographing even at night, in an underground, etc. which do not have a light (visible ray).

The watching camera includes a housing main body that is installed at a wall surface or a ceiling of a building and a camera module that is mounted on the housing main body.

At this time, the camera module is assembled using an angle control bracket that can optionally control the photographing direction or the angle, wherein the angle control bracket is formed in a structure having a multi-shaft freedom that can rotate the camera module in a left and right direction or control the angle in an up and down direction.

The watching camera in the related art is installed by controlling the installation direction and the photographing angle of the camera by workers in the field at the time of installing the watching camera.

However, the watching camera in the related art has a problem in the horizontality of the photographing screen is deviated during the installation process.

Herein, the horizontality means a state where an angle of a view of an image displayed on a monitor is parallel to a ground. When the horizontality is deviated, the image displayed on the monitor is seen in a sloped state.

Therefore, the worker performs the horizontality control operation to confirm whether the screen photographed by the watching camera is horizontal to a ground while performing the photographing angle control operation.

At this time, the watching camera in the related art displays the photographed image information through the monitor. The monitor is installed at separate places such as a guardroom, etc. that is far away from a work site installed with the watching camera, such that it is difficult for the worker to immediately confirm the horizontality of the screen displayed on the monitor.

Therefore, the worker in the field frequently transmits and receives communication to and from a monitoring personnel by using a wireless communication device, etc. to confirm the horizontality of the camera screen and control the horizontality according to the operation instructions of the monitoring personnel.

However, the above-mentioned related art cannot confirm the horizontality of the camera screen on the spot, such that separate monitoring personnel is needed or the worker in the field should directly perform the monitoring and the installation simultaneously, thereby making the operation of labor force inefficient.

In addition, the monitoring and the installation are performed at time difference, such that much time is consumed for installation, thereby making the construction time long.

### DISCLOSURE

### Technical Problem

The present invention proposes to solve the problems in the related art. It is an object of the present invention to provide a watching camera capable of directly controlling horizontality of a camera screen on the spot without performing a separate monitoring operation.

It is another object of the present invention to provide a watching camera with a horizontal display device that is mounted on a front surface of a camera module capable of confirming horizontality of a camera screen with the naked eye of a worker.

### Technical Solution

In order to achieve the above objects, according to the present invention there is provided a watching camera installed at a wall surface or a ceiling of a building, including: a light receiving display device having light-emits a lamp in response to a slope in a left and right direction of a camera module.

According to the present invention, there is provided a watching camera, including: a housing main body that is fixedly installed at a wall surface or a ceiling of a building; a camera module that is installed at the housing main body to acquire image information on a watching region; an angle control bracket that is installed at the bottom of the housing main body and is mounted to allow the camera module to have a multi-shaft freedom in up, down, left and right directions; and a horizontal display device that is installed at the camera module and light-emits a lamp in response to a slope in a left and right direction of the camera module.

The angle control bracket according to the present invention is configured to have a bottom frame that is connected to the bottom of the housing main body, a vertical frame that is connected on the bottom frame by a first rotation shaft to be rotated in a left and right direction; and a second rotation shaft that is hinge-connected on the vertical frame to allow the camera module to rotate in an up and down direction

The vertical frame according to the present invention includes shaft holes that are formed at each of the left and right blades having a cross section of a “U”-letter shape, wherein the shaft hole penetrates through the second rotation shaft and is manufactured in a long hole shape cut by a predetermined length in a vertical direction.

The camera module according to the present invention includes: a ring bracket that is hinge-connected to both side ends of the vertical frame; a lens body that is rotatably connected at the central portion of the ring bracket; a rotation ring that is connected to a lower outer peripheral edge of the lens body at the front surface of the ring bracket and is operated to rotate the lens body; a ring base that is connected to face the rotation ring at the rear surface of the ring bracket and finely controls the rotation of the rotation ring at a predetermined angle; and an image board that is connected to the lens body at the rear surface of the ring base and makes photographed images into digital data.

The horizontal display device according to the present invention includes: a sensor board that is installed between the ring base and the image board; a horizontal sensor that is installed on the sensor board to sense the horizontality of the lens body; and lamps that are each installed at left and right sides based on the center of the lens body, wherein the sloped lamp of the lamps is light-emitted by a signal from the horizontal sensor.

The horizontal display device is balanced between a left and right horizontal state when both lamps 145 at the left and right sides are not light-emitted.

### Advantageous Effects

The present invention according to the above-mentioned configuration includes the horizontal display device on the front surface of the camera module to confirm the horizontality of the camera screen with the naked eye of the worker; thereby directly controlling the horizontality of the screen of the camera on the spot without performing the separate monitoring operation. As a result, the installation can be very easily and conveniently performed, such that the installation time and construction time of the watching camera can be shortened, thereby making it possible to reduce the cost of construction.

### DESCRIPTION OF DRAWINGS

FIG. 1 is an exploded perspective view of a watching camera according to the present invention;

FIG. 2 is a side view of the watching camera according to the present invention;

FIG. 3 is a conceptual view showing an installation structure of a horizontal display device of the watching camera according to the present invention;

FIG. 4 is an exploded side view of the watching camera according to the present invention; and

FIG. 5 is an exploded plan view of the watching camera according to the present invention.

### BEST MODE

Hereinafter, exemplary embodiments of the present invention will be described in detail with reference to the accompanying drawings.

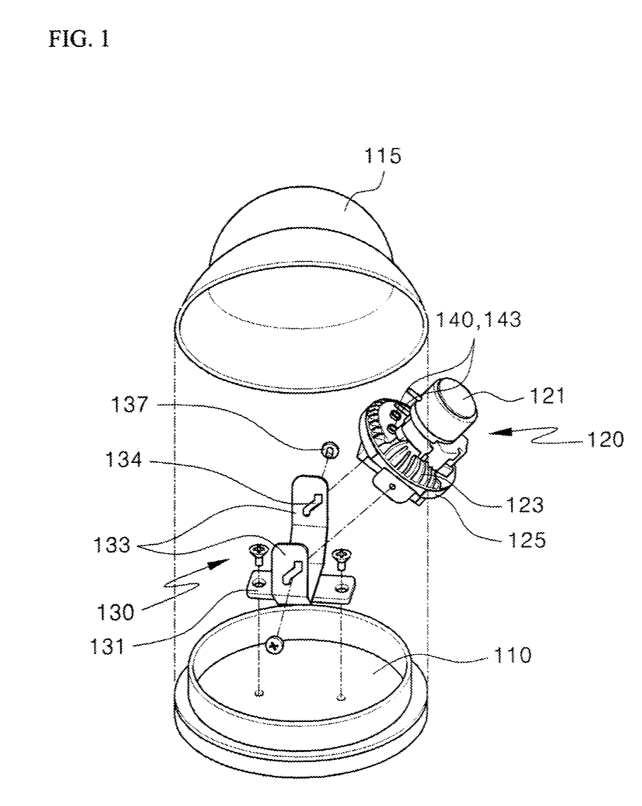

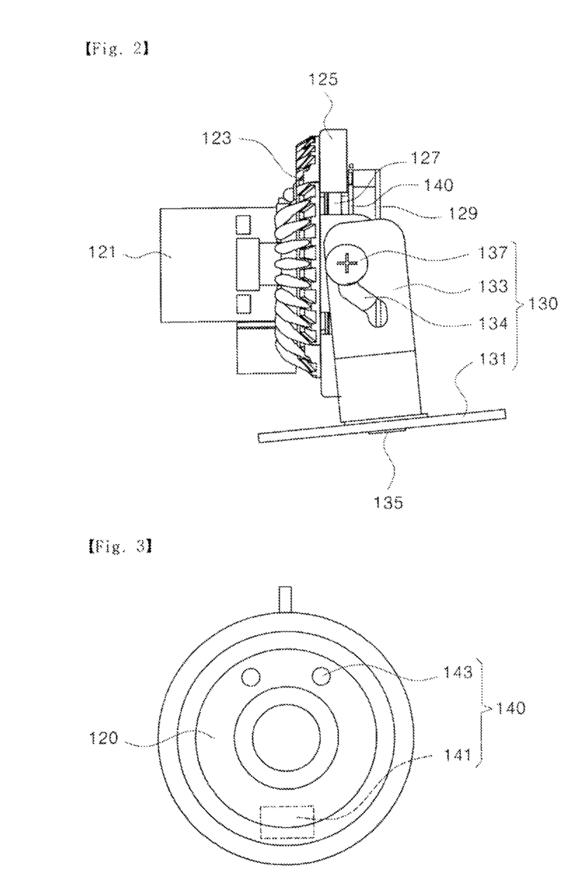

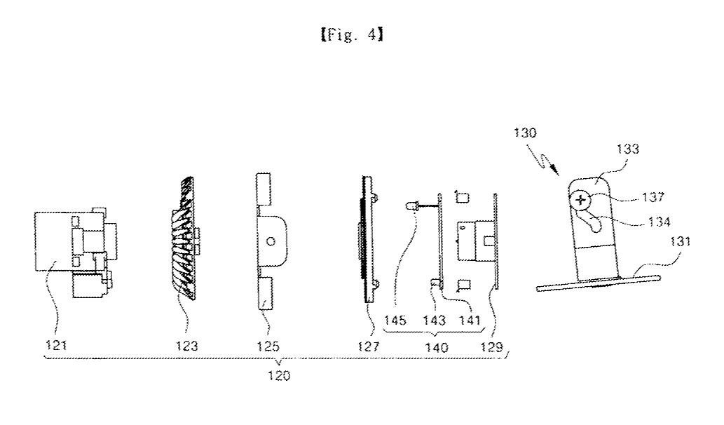

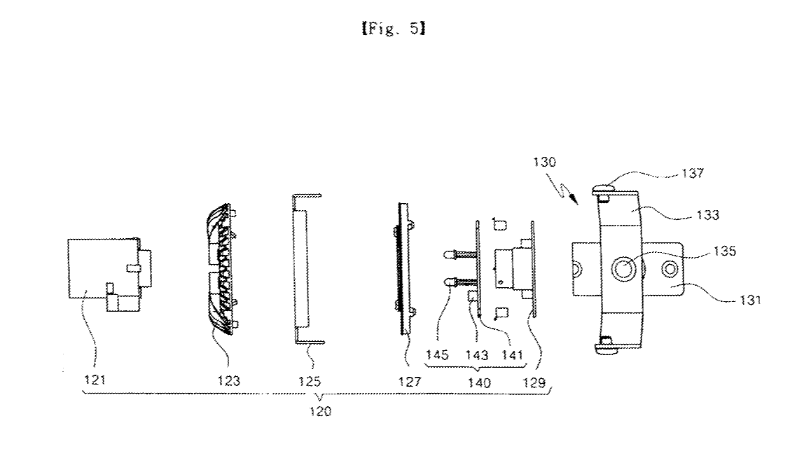

FIG. 1 is an exploded perspective view of a watching camera according to the present invention, FIG. 2 is a side view of the watching camera according to the present invention, FIG. 3 is a conceptual view showing an installation structure of a horizontal display device of the watching camera according to the present invention, FIG. 4 is an exploded side view of the watching camera according to the present invention, and FIG. 5 is an exploded plan view of the watching camera according to the present invention.

As shown in the drawings, the present invention relates to a watching camera that is installed at a wall surface or a ceiling of a building. The watching camera is configured to include a housing main body 110, a camera module 120, an angle control bracket 130, and a horizontal display device 140.

The housing main body 110, which is a component that is fixedly installed at a wail surface or a ceiling of a building, provides a base structure so that the camera module 120 and the angle control bracket 130 are installed.

The housing main body 110 may be manufactured in a circular plate shape and includes a dome shaped cover 115 connected to the upper portion thereof, such that the inner structure thereof cannot be exposed to the outside.

The bottom of the housing main body 110 is installed with the angle control bracket 130 having a multi-shaft freedom.

The angle control bracket 130 is a structure that mounts the camera module 120 to perform a free hinge driving in up, down, left and right directions.

The angle control bracket 130 is configured to include a bottom frame 131 that is connected to the bottom of the housing main body 110; a vertical frame 133 that is connected on the bottom frame 13 by a first rotation shaft 135 to be rotated in a left and right direction, and a second rotation shaft 137 that is hinge-connected to rotate the camera module in an up and down direction on the vertical frame.

At this time, the vertical frame 133 is manufactured in a structure having a cross-section of an “U”-letter shape and each of left and right blades thereof is formed with shaft holes 134 through which the second rotation shaft 137 penetrates. At this time, the shaft hole 134 may be manufactured in a long hole shape cut by a predetermined length in a vertical direction. In addition, the long hole may form a curved portion.

Therefore, when the camera module 120 is installed using the shaft hole 134 in the long hole shape having the curved portion, the fixed height of the camera module 120 can be controlled.

The configuration of the report processor 120 will be described in detail below.

The camera module 120 of the present invention is configured to include a ring bracket 125 that is hinge-connected to both side ends of the vertical frame 133; a lens body 121 that is rotatably connected at the central portion of the ring bracket 125; a rotation ring 123 that is connected to a lower outer peripheral edge of the lens body 121 at the front surface of the ring bracket 125 and is operated to rotate the lens body 121; a ring base 127 that is connected to face the rotation ring at the rear surface of the ring bracket 125 and finely controls the rotation of the rotation ring 123 at a predetermined angle; and an image board 129 that is connected to the lens body 121 at the rear surface of the ring base 127 and makes photographed images into digital data

Herein, the ring base 127 and the rotation ring 123 is an example of a structure that controls the mutual fine rotation, wherein a ring gear is formed at the rotation center of the ring base 127 and the rotation ring 123 may be formed with a plurality of stoppers that elastically contact teeth on the outer peripheral edge of the ring gear.

The horizontal display device 140 is installed between the image board 129 and the lens body 121 to send out a signal to a lamp 145, thereby making it possible to sense the horizontality (slope) of the lens body 121 and confirm the horizontality (slope) state of the lens body 121 with the naked eye of a worker.

Hereinafter, the configuration of the, horizontal display device 140 will be described in detail.

The horizontal display device 140 according to the present invention includes: a sensor board 141 that is installed between the ring base 127 and the image board 129; a horizontal sensor 143 that is installed on the sensor board 141 to sense the horizontality (slope) of the lens body 121; and lamps 145 that are each installed at left and right sides based on the center of the lens body 121, wherein the sloped lamp 145 of the lamps is light-emitted by a signal from the horizontal sensor 143

At this time, the lamp is extendedly installed to be protruded on the front surface of the rotation ring 123.

The above-mentioned horizontal display device 140 of the present invention displays the alignment state that the lamps are just in the left and right horizontal state when both lamps 145 at the left and right sides are not light-emitted.

Therefore, the worker sets the photographing angle in up, down, left and right directions by using the angle control bracket 130 and then operates the rotation ring 120 to rotate the lens body 121 so that both lamps 145 at the left and right sides are turned-off.

The present invention according to the above-mentioned configuration includes the horizontal display device 140 on the front surface of the camera module to confirm the horizontality of the camera screen with the naked eye of the worker, thereby making it possible to directly control the horizontality of the camera screen on the spot without performing the separate monitoring operation.

The present invention having the above-mentioned advantages can easily and rapidly install the watching camera to shorten the installation time and the construction time of the watching camera, thereby making it possible to reduce the cost of construction.

1. A watching camera installed at a wall surface or a ceiling of a building, comprising: a light receiving display device 140 having light-emits a lamp 145 in response to a slope in a left and right direction of a camera module 120.

2. A watching camera, comprising:
a housing main body 110 that is fixedly installed at a wall surface or a ceiling of a building;
a camera module 120 that is installed at the housing main body 110 to acquire image information on a watching region;
an angle control bracket 130 that is installed at the bottom of the housing main body 110 and is mounted to allow the camera module 120 to have a multi-shaft freedom in up, down, left and right directions; and
a horizontal display device 140 that is installed at the camera module 120 and light-emits a lamp 145 in response to a slope in a left and right direction of the camera module 120.

3. The watching camera according to claim 2, wherein the angle control bracket 130 includes:
a bottom frame 131 that is connected to the bottom of the housing main body 110
a vertical frame 133 that is connected on the bottom frame 131 by a first rotation shaft 135 to be rotated in a left and right direction; and
a second rotation shaft 137 that is hinge-connected on the vertical frame 133 to allow the camera module 120 to rotate in an up and down direction.

4. The watching camera according to claim 3, wherein the vertical frame includes shaft holes 134 that are formed at each of the left and right blades having a cross section of a “U”-letter shape, the shaft hole 134 penetrating through the second rotation shaft and manufactured in a long hole shape cut by a predetermined length in a vertical direction.

5. The watching camera according to claim 3, wherein the camera module 120 includes:
a ring bracket 125 that is hinge-connected to both side ends of the vertical frame 133;
a lens body 121 that is rotatably connected at the central portion of the ring bracket 125;
a rotation ring 123 that is connected to a lower outer peripheral edge of the lens body 121 at the front surface of the ring bracket 125 and is operated to rotate the lens body 121;
a ring base 127 that is connected to face the rotation ring 123 at the rear surface of the ring bracket 125 and finely controls the rotation of the rotation ring 123 at a predetermined angle; and
an image board 129 that is connected to the lens body 121 at the rear surface of the ring base 127 and makes photographed images into digital data.

6. The watching camera according to claim 5, wherein the horizontal display device 140 includes:
a sensor board 141 that is installed between the ring base 127 and the image board 129;
a horizontal sensor 143 that is installed on the sensor board 141 to sense the horizontality (slope) of the lens body 121; and
lamps 140 that are each installed at left and right sides based on the center of the lens body 121, wherein the sloped lamp of the lamps is light-emitted by a signal from the horizontal sensor 143.

7. The watching camera according to claim 6, wherein the horizontal display device is balanced between a left and right horizontal state when both lamps 145 at the left and right sides are not light-emitted.
